(19) United States
(12) Patent Application Publication
(10) Pub. No.: US 2015/0353204 A1
(43) Pub. Date: Dec. 10, 2015

(54) DISPLAY SYSTEM FOR USE IN A FLIGHT DECK OF AN AIRCRAFT

(71) Applicant: Gulfstream Aerospace Corporation, Savannah, GA (US)

(72) Inventors: Frank Manochio, Savannah, GA (US); Jason Meade, Savannah, GA (US); Charles Michaels, Savannah, GA (US)

(73) Assignee: Gulfstream Aerospace Corporation, Savannah, GA (US)

(21) Appl. No.: 14/173,156

(22) Filed: Feb. 5, 2014

(51) Int. Cl. B64D 43/00; G09G 5/14

(52) U.S. Cl. CPC B64D 43/00; G09G 5/14; G09G 2380/12

(57) ABSTRACT

A display system for use in a flight deck of an aircraft is disclosed herein. The flight deck has an instrument panel. The display system includes, but is not limited to, a display screen that is adapted for mounting to the instrument panel and that is configured to extend along substantially an entire lateral length of the instrument panel without any discontinuity of display capability. The display system includes, but is not limited to, a plurality of image sources associated with the display screen. The plurality of image sources is configured to cause a plurality of images to appear on the display screen.

### TECHNICAL FIELD

The present invention generally relates to aviation and more particularly relates to a display system for use on the flight deck of an aircraft, the flight deck having an instrument panel.

### BACKGROUND

The flight deck of a modern passenger aircraft commonly includes an instrument panel having multiple display screens. These display screens are used to present information to members of an aircrew. Each display screen is typically mounted in a frame or mounting bracket that, in turn, is mounted to the instrument panel. This mounting scheme yields a series of discrete display screens positioned next to one another in a horizontal arrangement extending along a lateral axis of the instrument panel, each display screen being separated from its neighboring display screen(s) by their respective frames/mounting brackets.

The amount of information that must be presented to the aircrew is quite substantial. Over the years, the display screens mounted to the instrument panel have grown horizontally (either in size or in number) to fill substantially all of the available lateral space on the instrument panel. In other words, the instrument panel of a typical modern aircraft has been filled “wall to wall” with display screens leaving virtually no room for the installation of any additional display screens.

Unfortunately, the amount of information that must be presented to the aircrew has also increased over the years, and it continues to grow. Consequently, more display space is needed. Expansion of the display screens in the vertical direction is not currently a desirable option. Extending the existing display screens in an upwards direction is limited by the need to maintain various control mechanisms (e.g., switches, knobs, actuators) on the instrument panel. Expansion in the downward direction is limited by the need to provide physical space for the pilot to sit and extend his or her legs. Accordingly, the use of “taller” display screens is not presently a viable option.

Accordingly, it would be desirable to provide a display system that offers more display area than is currently available without increasing the height of the display screens. In addition, it is desirable to provide a display system that more efficiently utilizes the existing lateral space on the instrument panel of an aircraft's flight deck. Furthermore, other desirable features and characteristics will become apparent from the subsequent summary and detailed description and the appended claims, taken in conjunction with the accompanying drawings and the foregoing technical field and background.

### BRIEF SUMMARY

A display system for use in a flight deck of an aircraft is disclosed herein. The fight deck includes an instrument panel.

In a first non-limiting embodiment, the display system includes, but is not limited to, a display screen that is adapted for mounting to the instrument panel and that is configured to extend along substantially an entire lateral length of the instrument panel without any discontinuity of display capability. The display system further includes, but is not limited to, a plurality of image sources that are associated with the display screen. The plurality of image sources is configured to cause a plurality of images to appear on the display screen.

In another non-limiting embodiment, the display system includes, but is not limited to, a display screen that is adapted for mounting to the instrument panel and that is configured to extend along substantially an entire lateral length of the instrument panel without any discontinuity of display capability. The display screen has a curved configuration. The display system further includes, but is not limited to, a plurality of image sources associated with the display screen. The plurality of image sources are configured to cause a plurality of images to appear on the display screen.

### BRIEF DESCRIPTION OF THE DRAWINGS

The present invention will hereinafter be described in conjunction with the following drawing figures, wherein like numerals denote like elements, and

FIG. 1 is a schematic view illustrating a flight deck having an instrument panel and a non-limiting embodiment of a display system made in accordance with the teachings of the present disclosure;

FIG. 2 is a perspective view illustrating the flight deck of FIG. 1;

FIG. 3 illustrates a non-limiting example of a display screen made in accordance with the teachings of the present disclosure positioned side-by-side with a conventional display screen;

FIG. 4 is a perspective view illustrating a non-limiting example of a curved display screen made in accordance with the teachings of the present disclosure;

FIG. 5 is a perspective view of another non-limiting example of a curved display screen made in accordance with the teachings of the present disclosure;

FIG. 6 is a perspective view illustrating a non-limiting example of a frame configured to engage a curved display screen; and

FIG. 7 is a perspective view of another non-limiting example of a display screen made in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved display system for use with an aircraft is disclosed herein. In a non-limiting embodiment, the display system of the present disclosure employs a display screen that extends across substantially the entire instrument panel in the lateral direction without any disruption or discontinuity in its ability to present information to an aircrew. Unlike conventional display systems which position a plurality of individual display screens/monitors side by side along the lateral axis of an instrument panel, the display screen of the present display system comprises a continuous viewing screen that extends laterally along substantially the entire length of the instrument panel in a continuous, uninterrupted expanse of display surface. Unlike the conventional arrangement described above, the viewing screen of the present disclosure has no vertical disruptions along its lateral axis such as frames or mounting brackets that would interfere with the display screen's ability to present images, graphics, text, and the like to an aircrew. Accordingly, the surface area that is consumed by the frames and mounting brackets of a conventional instrument panel is recaptured by the display system of the present disclosure and, in turn, provides a substantial increase in the surface area that is available for displaying information to an aircrew.

In another non-limiting embodiment, the display screen has a curved configuration rather than a planar configuration. In some such embodiments, the display screen may be curved in a concave manner from the perspective of the aircrew. By adding curvature to the display screen, the surface area that is available for the display of graphics, text, and/or other images is even further increased as compared with conventional display systems.

In a non-limiting embodiment, the display system includes multiple image sources. For example, in embodiments where the display system utilizes a rear projection screen, the multiple image sources may each comprise a rear projector configured to project images onto a rear projection screen. Each image source is positioned to present an image on a portion of the display screen. In some embodiments, each image source may present an image on a corresponding portion of the display screen exclusive of other images. In other embodiments, one or more of the image sources may present an image on the display screen that overlaps with another image projected by another image source. In other examples, the display screen may be a conventional monitor having a width that extends along substantially the entire lateral length of the instrument panel. Such a monitor may be communicatively coupled with multiple projectors or other signal sources capable of transmitting redundant signals. In either configuration, the use of multiple image sources reduces the risk of loss of information that might otherwise occur if the system utilized only a single image source and if that single image source experienced a malfunction.

In some embodiments, a processor is operatively coupled to each image source. The processor may be configured to control each image source and thereby coordinate and schedule the presentation of information in a manner suitable for presentation to an aircrew.

A greater understanding of the display system described above may be obtained through a review of the illustrations accompanying this application together with a review of the detailed description that follows.

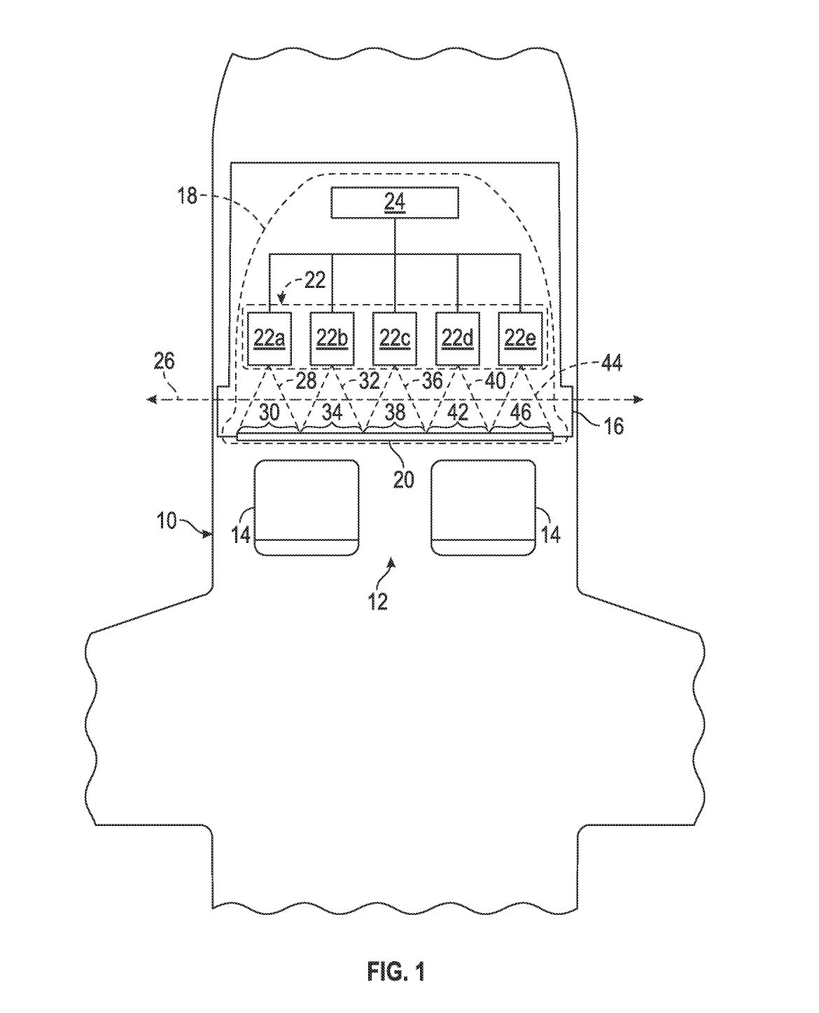

FIG. 1 is a schematic view illustrating an aircraft 10. Aircraft 10 may comprise any type of aircraft including, but not limited to, a fixed wing aircraft, a rotary aircraft, a passenger airliner, a business jet, a commercial aircraft, a military aircraft, a propeller driven aircraft, a jet powered aircraft, and the like.

Aircraft 10 includes a flight deck 12 for seating an aircrew (not shown). In the illustrated embodiment, flight deck 12 is configured to accommodate both a pilot and a co-pilot seated side by side. Despite this depiction, it should be understood that the teachings of the present disclosure are applicable to aircraft that are constructed to accommodate a single aircrew member or to flight decks that are configured to accommodate a two-person aircrew seated in a tandem arrangement. Other seating arrangements may also be employed without departing from the teachings of the present disclosure.

Flight deck 12 includes a pair of seats 14 positioned to support flight crew members in front of an instrument panel 16. Flight deck 12 is equipped with a non-limiting embodiment of a display system 18. In the illustrated embodiment, display system 18 includes a display screen 20, a plurality of image generators 22a, 22b, 22c, 22d, and 22e, and a processor 24. In other embodiments, display system 18 may include either fewer components or a greater number of components without departing from the teachings of the present disclosure. For example, additional or fewer image generators 22 may be utilized. Furthermore, each image generator may, itself, comprise a processor which would obviate the need for a dedicated processor 24. Also, a frame member or other structural component may be included to permit the mounting of display screen 20 to instrument panel 16.

In the illustrated embodiment, display system 18 is housed, at least partially, in instrument panel 16. For example, display screen 20 is mounted to instrument panel 16. In some embodiments, this may be accomplished with a frame that engages with display screen 20 about its periphery, as discussed in greater detail below. By mounting display screen 20 to instrument panel 16, members of the aircrew may readily see/access the information presented on display screen 20. In some embodiments, image generators 22 may also be mounted to instrument panel 16, behind display screen 20, in a position that is concealed from the aircrew. In still other embodiments, all components of display system 18 may be mounted to instrument panel 16. The mounting of image generators 22 to the same structural component that display screen 20 is mounted to (e.g., instrument panel 16) may be particularly advantageous in embodiments where display system 18 employs rear projectors. Such a mounting arrangement will allow display screen 20 and image generators 22 to move in unison when aircraft 10 encounters turbulence or other sudden or disrupting motion. This, in turn, will contribute to the maintenance of a steady, stable, and substantially unwavering image on display screen 20.

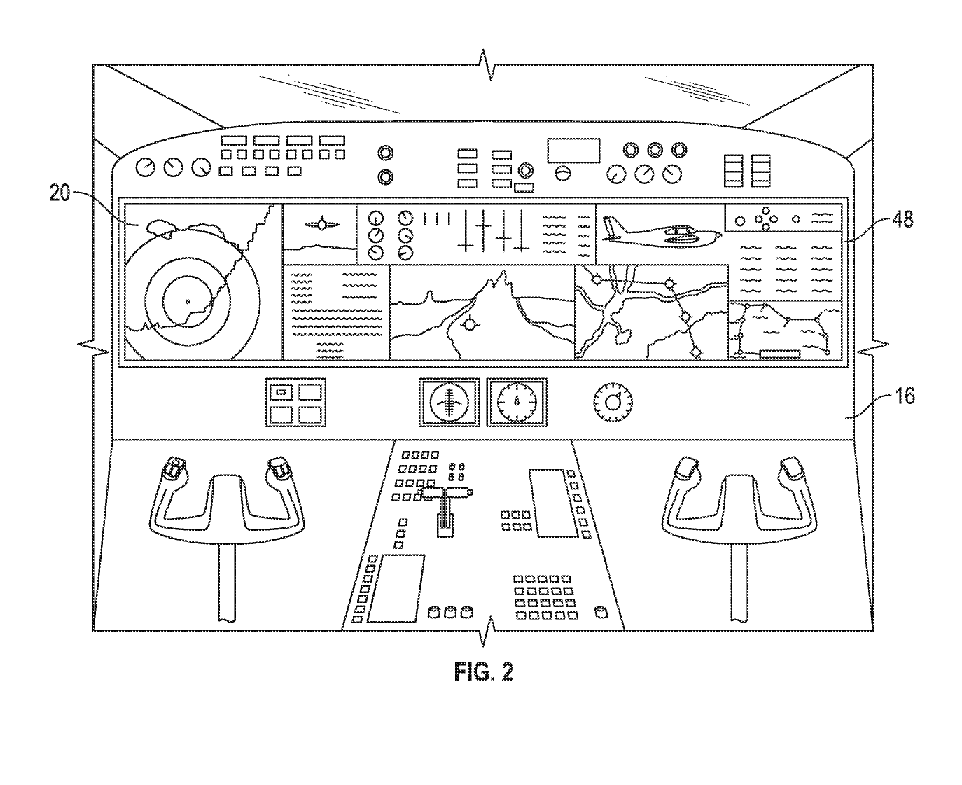

As illustrated in FIG. 1, display screen 20 comprises a single component (i.e., a unitary, monolithic structure) that extends along a lateral axis 26 of instrument panel 16. By comprising a single component, display screen 20 is able to overcome one of the disadvantages of conventional arrangements—it eliminates the presence of interior brackets, frames or other supporting/housing structures. As best illustrated in FIG. 2, this provides the aircrew with a visually uninterrupted display screen that is capable of presenting images and text to the aircrew at substantially any location across substantially the entire lateral length of instrument panel 16. This provides the aircrew with greater flexibility in the positioning and/or relocation of images than is currently afforded by conventional display systems. As discussed in greater detail below, in other embodiments, display screen 20 may comprise a plurality of discrete screen sections that are positioned adjacent one another such that, in the aggregate, they cooperate to provide the aircrew with a visually uninterrupted display screen that is capable of presenting images to the aircrew at substantially any location across substantially the entire lateral length of instrument panel 16.

In FIG. 1, display screen 20 comprises a single pane of glass or other suitable material that is configured as a rear projection screen and that is compatible for use with one or more rear projectors. In other embodiments, display screen 20 may comprise a conventional monitor or display screen that is configured for use with a conventional display system and that is further configured to extend along substantially the entire lateral length of instrument panel 16 without any discontinuity of display capability. As used herein, the phrase “without any discontinuity of display capability” refers to a display screen's ability to display images at any and all points along its surface without obstruction.

Image generators 22 may each comprise any device, machine or other contrivance that is capable of causing an image to appear on display screen 20. For example, and without limitation, image generators 22a, 22b, 22c, 22d, and 22e may each comprise a projector, a rear projector, a processor, or the like. In the embodiment illustrated in FIG. 1, image generators 22a, 22b, 22c, 22d, and 22e each comprise a rear projector (e.g., rear projection cameras) and display screen 20 comprises a rear projection screen.

In the illustrated embodiment, each image generator 22 is positioned with respect to display screen 20 such that a respective image generated by each image generator 22 will project onto, and will be visible at, a discrete and exclusive (i.e., non-overlapping) portion of display screen 20. For example, an image 28 generated by image generator 22a will appear on portion 30 of display screen 20. An image 32 generated by image generator 22b will appear on portion 34 of display screen 20. An image 36 generated by image generator 22c will appear on portion 38 of display screen 20. An image 40 generated by image generator 22d will appear on portion 42 of display screen 20. And an image 44 generated by image generator 22e will appear on portion 46 of display screen 20. As illustrated, images 28, 32, 36, 40 and 44 are displayed adjacent one another which, from the perspective of the aircrew, would appear to be one continuous uninterrupted image extending in a lateral direction across the entire display screen 20.

As illustrated in FIG. 1, image 28, image 32, image 36, image 40 and image 44 are projected onto respective portions of displays screen 20 that are adjacent one another and that do not overlap. This projection scheme reduces the possibility that the individual images may interfere with one another. In other embodiments, it may be desirable to employ a projection scheme wherein the individual images do overlap to provide redundancy. Redundancy may be desirable in the event that an image generator malfunctions.

Processor 24 may be any type of onboard computer, controller, micro-controller, circuitry, chipset, computer system, or microprocessor that is configured to perform algorithms, to execute software applications, to execute sub-routines and/or to be loaded with and to execute any other type of computer program. Processor 24 may comprise a single processor or a plurality of processors acting in concert. In some embodiments, processor 24 may be dedicated for use exclusively with display system 18 while in other embodiments processor 24 may be shared with other systems on board aircraft 10.

Processor 24 is operatively coupled to image generators 22a, 22b, 22c, 22d, and 22e. Such operative coupling may be effected through the use of any suitable means of transmission including both wired and wireless connections. For example, each component may be physically connected to processor 24 via a coaxial or optical cable or via any other type of connection effective to convey signals. In the illustrated embodiment, processor 24 is directly communicatively coupled to each image generator 22. In other embodiments, each component may be communicatively coupled to processor 24 across a communication bus. In still other examples, each image generator 22 may be wirelessly coupled with processor 24 via a Bluetooth connection, a WiFi connection or the like.

Being operatively coupled provides a pathway for the transmission of commands, instructions, interrogations and other signals between processor 24 and each image generator 22. Through this communicative coupling, processor 24 may control and/or communicate with each of the image generators 22. Each of the image generators 22 may be configured to interface and engage with processor 24. For example, each image generator 22 may be configured to receive commands from processor 24 and to display graphical images on display screen 20 in response to such commands.

Processor 24 is configured to interact with, coordinate and/or orchestrate the activities of each of the image generators 22 for the purpose of enhancing the flight crew's ability to operate aircraft 10. For example, processor 24 may be programmed and/or otherwise configured to control and coordinate the image that each image generator 22 generates on display screen 20. Processor 24 may be communicatively coupled with one or more sensors and one or more communication devices on board aircraft 10, it may receive information from such sensors and/or communication devices, and it may instruct one or more image generators 22 to display information relating to and/or corresponding with such information. Processor 24 may be configured to instruct some or all image generators 22 to present a respective image on a specific portion of display screen 20. Processor 24 may be configured to instruct different image generators 22 to generate different portions of a single image in a manner that aligns to form a composite image. Processor 24 may be configured to instruct some or all image generators 22 to overlap their respective images onto one or more portions of display screen 20 for purposes of redundancy and/or clarity. Processor 24 may be configured to receive inputs from one or more members of an aircrew of aircraft 10 relating to where that aircrew member desires to have an output, an image or data displayed on display screen 20 and in response, processor 24 may be configured to instruct one or more of the image generators 22 to generate an image onto display screen 20 in a manner that conforms to such instructions.

FIG. 2 is a perspective view looking forward into flight deck 12. As illustrated, display screen 20 is mounted to instrument panel 16 via a frame 48 and extends across substantially the entire lateral length of instrument panel 16. Frame 48 is configured to engage with a periphery of display screen 20. Configured in this manner, frame 48 contributes to the ability of display screen 20 to present images along its entire surface in the lateral direction without the disruption caused by the frames and/or mounting brackets used to support conventional display screens.

FIG. 2 demonstrates the advantages of a display screen that extends across substantially the entire lateral length of instrument panel 16. With continuing reference to FIG. 1, the absence of vertical structures that would otherwise disrupt the display area of display screen 20 enables display system 18 to project images at any suitable and/or desirable position along the lateral length of display screen 20. This provides not only greater flexibility in the presentation of images to members of an aircrew, but it also provides a greater amount of surface area on which to project images.

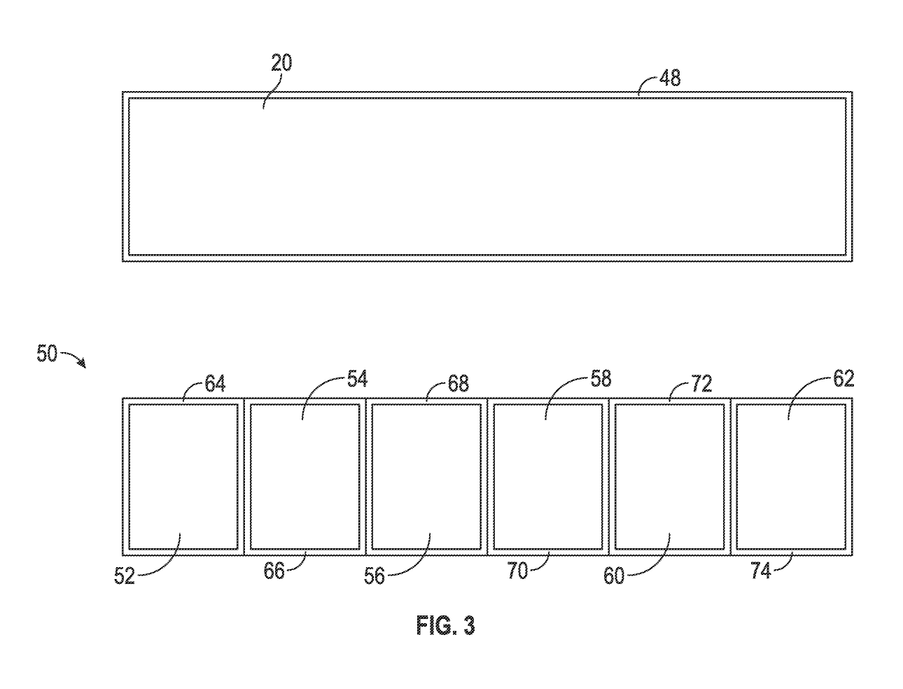

FIG. 3 illustrates display screen 20 positioned side-by-side with a conventional display screen arrangement 50. Display screen 20 is supported by frame 48. As discussed above, display screen 20 is a single component and frame 48 is configured to leave substantially all of the surface area of display screen 20 available for the presentation of images. By contrast, conventional display screen arrangement 50 includes six discrete monitors (monitor 52, monitor 54, monitor 56, monitor 58, monitor 60, and monitor 62) arranged side by side. Each monitor includes an outer frame (frame 64, frame 66, frame 68, frame 70, frame 72, and frame 74). The vertical portions of each frame extend vertically across the composite screen formed by the aggregation of monitors 52, 54, 56, 58, 60, and 62. Thus, the vertical portions disrupt the composite screen's ability to present continuous and contiguous images along the lateral axis of an instrument panel. These vertical portions consume a substantial amount of the finite space that is available for the presentation of images. This side-by-side comparison makes clear the advantage that display screen 20 provides over conventional display screen arrangement 50.

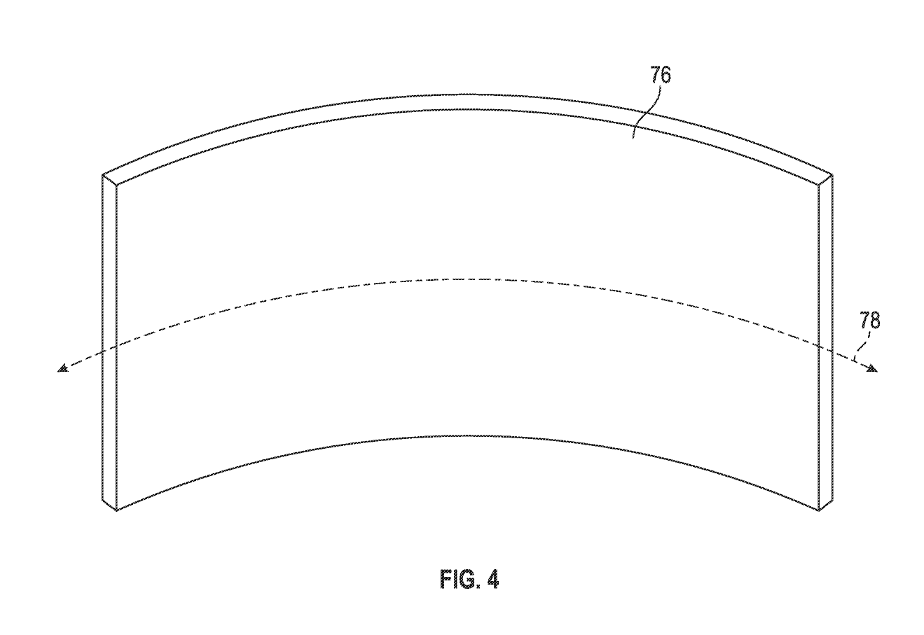

With continuing reference to FIGS. 1-3, FIG. 4 is a perspective view of an alternate embodiment of a display screen 76 that is also compatible for use with display system 18. Whereas display screen 20 has a substantially planar configuration, display screen 76 is curved along its lateral axis 78. By curving display screen 76 along lateral axis 78, an even larger amount of surface area is provided by display screen 76 (as compared with display screen 20) for the presentation of images within the confines of the mounting area provided by instrument panel 16. In some embodiments, display screen 76 may be a rear projection screen. In other embodiments, display screen 76 may employ any other technology suitable for the presentation of text and graphic images by a display system.

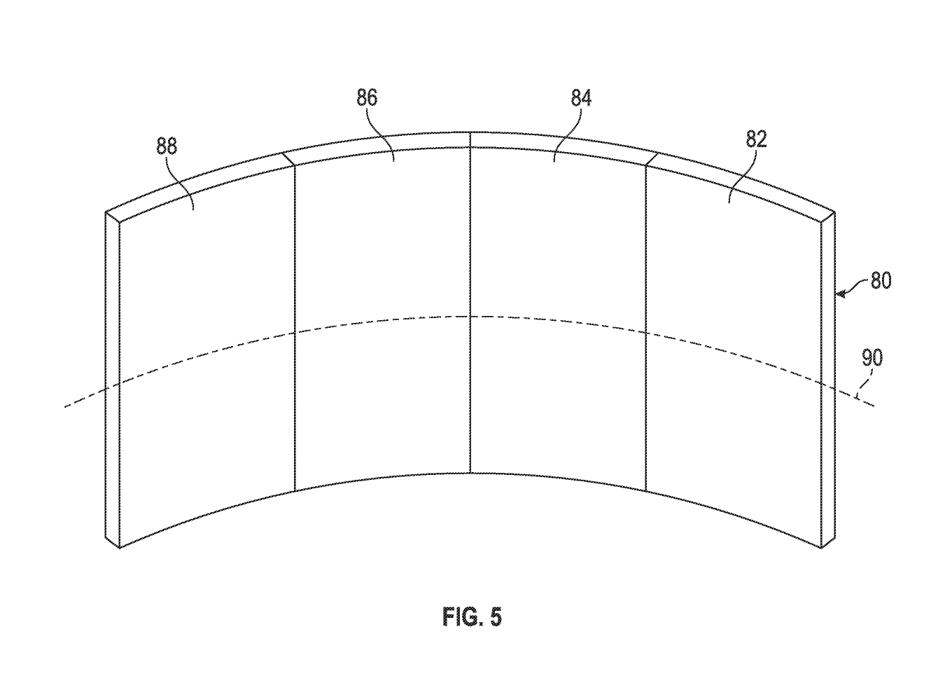

With continuing reference to FIGS. 1-4, FIG. 5 is a perspective view of an alternate embodiment of a display screen 80 that is also compatible for use with display system 18. As compared with display screens 20 and 76, which were both single component screens, display screen 80 is a composite screen comprised of multiple sections (section 82, section 84, section 86, and section 88) positioned adjacent one another along lateral axis 90 to form a composite screen suitable for displaying images along substantially its entire lateral length. By employing a composite screen instead of a single component screen, the costs associated with making repairs can be reduced. For example, if a portion of display screen 20 or display screen 76 is damaged, the entire screen may need to be replaced, whereas if a portion of display screen 80 is damaged, only the individual section where the damage occurred would need to be replaced. Although display screen 80 is depicted as having a curved configuration, it should be understood that in other embodiments, display screen 80 may have a planar configuration. In some embodiments, display screen 80 may be a rear projection screen. In other embodiments, display screen 80 may employ any other technology suitable for the presentation of text and graphic images by a display system.

With continuing reference to FIGS. 1, 4, and 5, when a display system of the present disclosure employs a display screen having a curvature, (e.g., display screen 76 and display screen 80), special accommodations should be made to ensure that the display of images/text on the curved portions of the display screen are not distorted. For example, in instances where the display system employs a rear projector screen and multiple rear projectors, each rear projector may be fitted with a lens that bends and/or curves the image in a way that cause the image to appear unbent and un-curved when displayed on the curved portion(s) of the display screen. In instances where the display system employs multiple processors to project images displayed on a curved, conventional monitor, each processor may be programmed with software that causes the image to appear unbent and un-curved when displayed on the curved portion(s) of the display screen. By fitting such rear projectors with an appropriate lens or by loading such processors with appropriate software, these image generators are enabled to render suitable images on their respective display screens (e.g., images that are not warped or distorted).

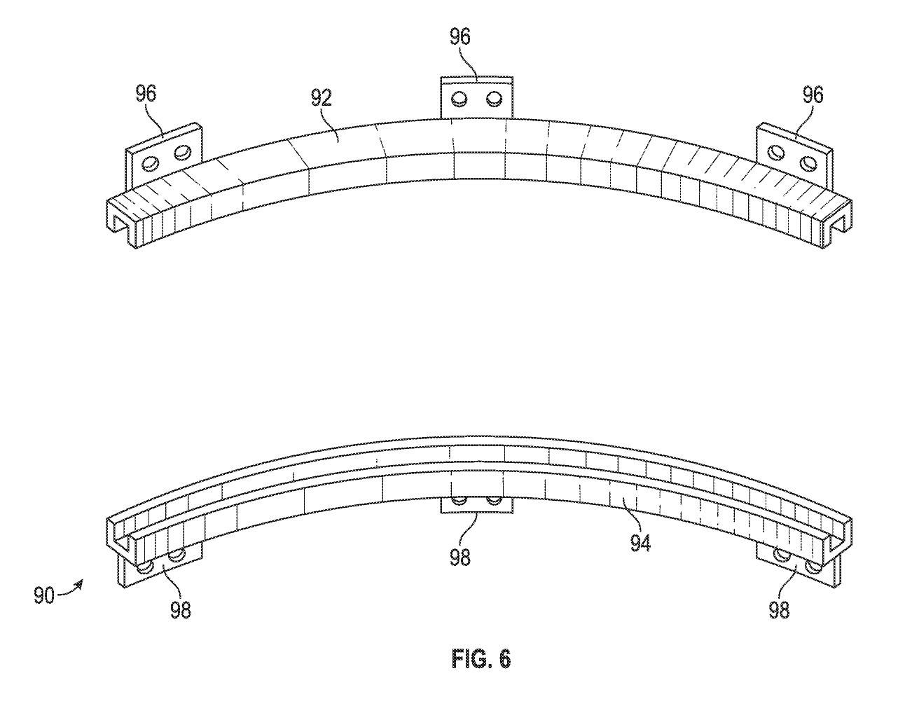

With respect to FIG. 6, a perspective view of a frame 90 is illustrated. With continuing reference to FIGS. 1-5, frame 90 has a curvature along its lateral axis that permits frame 90 to engage with a periphery of a curved display screen such as display screen 76 or display screen 80. Frame 90 is further configured to be mounted to instrument panel 16. In the illustrated embodiments, frame 90 includes an upper channel 92 and a lower channel 94 for respectively engaging an upper periphery and a lower periphery of a display screen. Upper channel 92 includes a plurality of mounting brackets 96 and lower channel 94 includes a plurality of mounting brackets 98 which are configured to receive fasteners and which facilitate the mounting of a display screen to an instrument panel. Although frame 90 is illustrated as having a substantially consistent curvature along its lateral axis, it should be understood that in other embodiments, frame 90 may have any suitable curvature and configuration necessary to permit frame 90 to engage with a respective display screen. In embodiments where the display screen is made of a flexible material, any desired curvature may be imparted to the display screen by using a frame having the desired curvature. By engaging the periphery of such a flexible display screen, the frame may support the flexible display screen in the desired curved configuration.

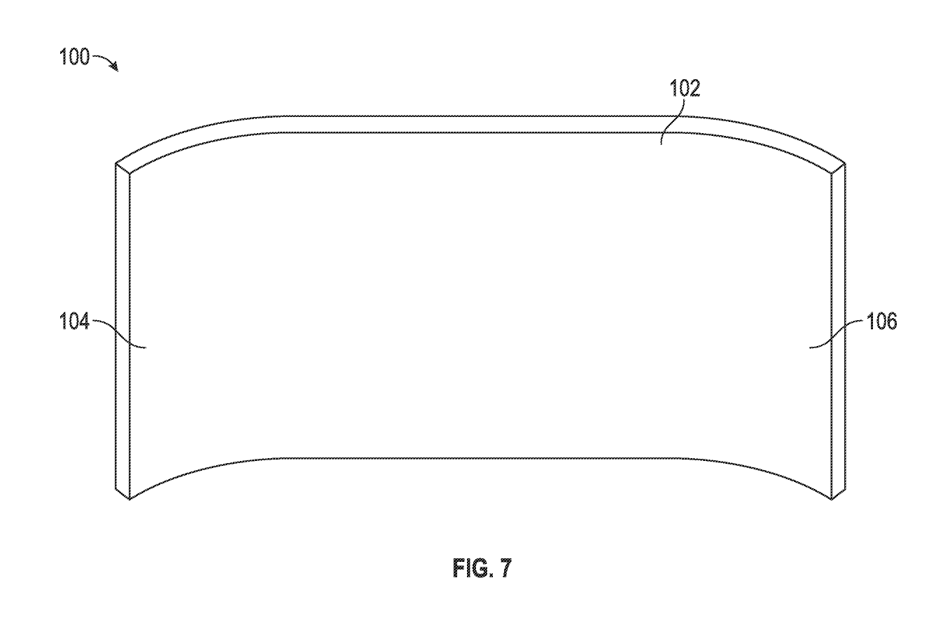

With continuing reference to FIGS. 1-6, FIG. 7 is a perspective view of an alternate embodiment of a display screen 100 compatible for use with display system 18. Whereas display screen 20 has a substantially planar configuration, and whereas display screen 76 and 80 are each curved continuously along their respective lateral axes, display screen 100 has both a substantially planar portion 102 located in a central region of display screen 100 as well as a pair of curved portions 104 and 106 at opposite ends of display screen 100. By curving display screen 100 in the manner illustrated in FIG. 7, a substantially planar screen may be provided with a wrap-around feature at the distal ends of the display screen. This configuration may allow display system 18 to take advantage of space on the instrument panel that had not previously been utilized to support monitors or display screens. In some embodiments, display screen 100 may be a rear projection screen. In other embodiments, display screen 100 may employ any other technology suitable for the presentation of text and graphic images by a display system.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A display system for use in a flight deck of an aircraft, the flight deck having an instrument panel, the display system comprising:
a display screen adapted for mounting to the instrument panel and configured to extend along substantially an entire lateral length of the instrument panel without any discontinuity of display capability; and
a plurality of image sources associated with the display screen, the plurality of image sources configured to cause a plurality of images to appear on the display screen.

2. The display system of claim 1, further comprising a processor operatively coupled with the plurality of image sources, the processor configured to control the plurality of image sources and to coordinate the appearance of the plurality of images on the display screen.

3. The display system of claim 2, wherein the processor is configured to control the plurality of image sources to cause each image of the plurality of images to appear at a corresponding and exclusive portion of the display screen.

4. The display system of claim 3, wherein each corresponding portion of the display screen is substantially adjacent to each neighboring corresponding portion of the display screen.

5. The display system of claim 1, wherein the display screen comprises a single structure.

6. The display system of claim 1, wherein the display screen comprises a plurality of subsections, and wherein the plurality of subsections are assembled together such that each subsection is abutted against each neighboring subsection.

7. The display system of claim 1, wherein the display screen comprises a rear projection screen and wherein each image source of the plurality of image sources comprises a projector.

8. The display system of claim 1, further comprising a frame adapted for mounting to the instrument panel, the frame engaging a periphery of the display screen and configured to support the display screen on the instrument panel.

9. A display system for use in a flight deck of an aircraft, the flight deck having an instrument panel, the display system comprising:
a display screen adapted for mounting to the instrument panel and configured to extend along substantially an entire lateral length of the instrument panel without any discontinuity of display capability, the display screen having a curved configuration; and
a plurality of image sources associated with the display screen, the plurality of image sources configured to cause a plurality of images to appear on the display screen.

10. The display system of claim 9, further comprising a processor operatively coupled with the plurality of image sources, the processor configured to control the plurality of image sources and to coordinate the appearance of the plurality of images on the display screen.

11. The display system of claim 9, wherein the display screen has a curved configuration along a lateral axis of the display screen.

12. The display system of claim 11, wherein the display screen has a curved configuration along substantially an entire length of the lateral axis of the display screen.

13. The display system of claim 11, wherein the display screen comprises a substantially planar central region, and wherein a first lateral end is curved and a second lateral end is curved.

14. The display system of claim 9, wherein the curved configuration comprises a concave curvature from a perspective of an occupant of the flight deck.

15. The display system of claim 9, wherein the display screen comprises a rear projection screen and wherein the plurality of image sources comprises a plurality of projectors.

16. The display system of claim 15, wherein at least one projector of the plurality of projectors includes a lens configured to warp a respective image such that the respective image is thereby rendered suitable for display on a curved portion of the display screen.

17. The display system of claim 15, further comprising a processor operatively coupled with the plurality of image sources, the processor configured to control the plurality of image sources and to coordinate the appearance of the plurality of images on the display screen, the processor further configured to warp at least one image of the plurality of images such that the at least one image is thereby rendered suitable for display on a curved portion of the display screen.

18. The display system of claim 9, wherein the display screen comprises a single structure.

19. The display system of claim 9, wherein the display screen comprises a plurality of subsections, each subsection of the plurality of subsections being abutted against each neighboring subsection.

20. The display system of claim 9, further comprising a frame adapted for mounting to the instrument panel, the frame engaging a periphery of the display screen and configured to support the display screen on the instrument panel.
